(19) United States
(12) Patent Application Publication
(10) Pub. No.: US 2022/0064050 A1
(43) Pub. Date: Mar. 3, 2022

(54) APPARATUS FOR HOLDING GLASSWARE DURING PROCESSING

(71) Applicant: CORNING INCORPORATED, Corning, NY (US)

(72) Inventors: Kyle Christopher Hoff, Painted Post, NY (US); Mark Edwin Lee Mack, Millport, NY (US); Matthew Carl Morse, Horseheads, NY (US)

(21) Appl. No.: 17/412,317

(22) Filed: Aug. 26, 2021

Related U.S. Application Data
(60) Provisional application No. 63/072,988, filed on Sep. 1, 2020.

(51) Int. Cl. C03B 35/00; C03C 3/06; C03C 10/00; C03C 23/00; C03C 21/00

(52) U.S. Cl. CPC C03B 35/005; C03C 3/06; C03C 21/002; C03C 23/007; C03C 10/0045

(57) ABSTRACT

An apparatus for holding glassware during processing includes a plurality of ware keepers, each ware keeper configured to receive a piece of glassware during the processing. Each ware keeper comprises a glass contact surface comprising a silicate material having a Knoop hardness less than or equal to 400 HK₂₀₀ and a specific gravity greater than or equal to 1.5 and less than or equal to 6.

### CROSS REFERENCE TO RELATED APPLICATIONS

This application claims the benefit of priority under 35 U.S.C. § 119 of U.S. Provisional Application Ser. No. 63/072,988 filed on Sep. 1, 2020, the content of which is relied upon and incorporated herein by reference in its entirety.

### BACKGROUND

### Field

The present specification relates to apparatuses for holding glassware during processing.

### Technical Background

Historically, glass has been used as a preferred material for many applications, including food and beverage packaging, pharmaceutical packaging, kitchen and laboratory glassware, and windows or other architectural features, because of its hermeticity, optical clarity, and excellent chemical durability relative to other materials.

However, use of glass for many applications is limited by the mechanical performance of the glass. In particular, glass breakage is a concern, particularly in the packaging of food, beverages, and pharmaceuticals. Breakage may be costly in the food, beverage, and pharmaceutical packaging industries because, for example, breakage within a filling line may require that neighboring unbroken containers be discarded as the containers may contain fragments from the broken container. Breakage may also require that the filling line be slowed or stopped, lowering production yields. Further, non-catastrophic breakage (i.e., when the glass cracks but does not break) may cause the contents of the glass package or container to lose their sterility which, in turn, may result in costly product recalls.

One root cause of glass breakage is the introduction of flaws in the surface of the glass as the glass is processed and/or during subsequent filling. These flaws may be introduced in the surface of the glass from a variety of sources including contact between adjacent pieces of glassware and contact between the glass and equipment, such as handling and/or filling equipment. Regardless of the source, the presence of these flaws may ultimately lead to glass breakage.

Accordingly, a need exists for alternative apparatuses for holding glassware during processing to mitigate glass damage.

### SUMMARY

According to a first aspect A1, an apparatus for holding glassware during processing may comprise: a plurality of ware keepers, each ware keeper configured to receive a piece of glassware during the processing, wherein: each ware keeper comprises a glass contact surface comprising a silicate material having a Knoop hardness less than or equal to 400 HK200 and a specific gravity greater than or equal to 1.5 and less than or equal to 6.

A second aspect A2 includes the apparatus according to the first aspect A1, wherein the silicate material comprises a phyllosilicate mineral.

A third aspect A3 includes the apparatus according to the second aspect A2, wherein the phyllosilicate mineral comprises talc, mica, or a combination thereof.

A fourth aspect A4 includes the apparatus according to the first aspect A1, wherein the silicate material comprises a tectosilicate mineral.

A fifth aspect A5 includes the apparatus according to the fourth aspect A4, wherein the tectosilicate mineral comprises quartz, feldspar, feldspathoid, or a combination thereof.

A sixth aspect A6 includes the apparatus according to the fifth aspect A5, wherein the feldspar comprises microcline, albite, sanidine, othroclase, labradorite, anorthite, or a combination thereof.

A seventh aspect A7 includes the apparatus according to the fifth aspect A5, wherein the feldspathoid comprises nepheline, leucite, or a combination thereof.

An eight aspect A8 includes the apparatus according to the first aspect A1, wherein the silicate material has a specific gravity greater than or equal to 1.5 and less than or equal to 4.

A ninth aspect A9 includes the apparatus according to the first aspect A1, wherein glass contact surface has a scratch parameter less than or equal to 75 μm with respect to the glassware contacting the glass contact surface as measured at an applied force less than or equal to 45 N.

A tenth aspect A10 includes the apparatus according to the first aspect A1, wherein the glass contact surface has a coefficient of friction less than or equal to 0.5 with respect to the glassware contacting the glass contact surface as measured at an applied force less than or equal to 45 N.

An eleventh aspect A11 includes the apparatus according the first aspect A1, wherein the silicate material does not adhere to the glassware contacting the glass contact surface at an exposure temperature less than or equal to 750° C. for 24 hours.

A twelfth aspect A12 includes the apparatus according to the first aspect A1, wherein the processing is ion exchange.

A thirteenth aspect A13 includes the apparatus according to the twelfth aspect A12, wherein the silicate material comprises feldspar.

A fourteenth aspect A14 includes the apparatus according to the first aspect A1, wherein the processing is annealing.

A fifteenth aspect A15 includes the apparatus according to the fourteenth aspect A14, wherein the silicate material comprise talc, mica, or a combination thereof.

A sixteenth aspect A16 includes the apparatus according to the first aspect A1, wherein the apparatus further comprises a base frame, wherein each ware keeper extends from the base frame and defines and circumscribes a glassware receiving volume in which the glassware is received and retained and the glass contact surface is positioned within the glassware receiving volume.

A seventeenth aspect A17 includes the apparatus according to the sixteenth aspect A16, wherein the plurality of ware keepers comprises a plurality of receiving slots, each receiving slot receiving at least a portion of the glassware, the receiving slots being arrayed in a linear array.

A eighteenth aspect A18 includes the apparatus according to the first aspect A1, wherein the apparatus further comprises a conveyor belt comprising a plurality of metal laths, wherein: the plurality of ware keepers are positioned on the conveyor belt such that pairs of glass contact surfaces form glassware receiving slots on the conveyor belt; and when the glassware is disposed on the conveyor belt within the glassware receiving slots, the glassware is exclusively contacted by the pairs of glass contact surfaces.

A nineteenth aspect A19 includes the apparatus according to the eighteenth aspect A18, wherein the glassware receiving slots are V-shaped.

A twentieth aspect A20 includes the apparatus according to the nineteenth aspect A19, wherein the pairs of glass contact surfaces forming the glassware receiving slots are configured to contact at least one of a curved bottom edge and a neck of the glassware.

Additional features and advantages of the apparatuses described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross-sectional view of a piece of glassware, according to one or more embodiments described herein;

FIG. 2 schematically depicts a perspective view of a conventional apparatus for holding glassware;

FIG. 3A schematically depicts a perspective view of an apparatus for holding glassware loaded with glassware, according to one or more embodiments shown and described herein;

FIG. 3B schematically depicts a perspective view of a ware keeper of the apparatus shown in FIG. 3A;

FIG. 4 schematically depicts a perspective view of another apparatus for holding glassware loaded with glassware, according to one or more embodiments shown and described herein;

FIG. 5 is a plot of coefficient of friction versus scratch length of a scratch test using a silicate material, according to one or more embodiments described herein;

FIG. 6 is a photograph of an initial portion of a scratch on a glass vial generated by a silicate material, according to one or more embodiments described herein;

FIG. 7 is a photograph of the end portion of the scratch shown in FIG. 6;

FIG. 8 is a photograph of a scratch on a glass vial generated by a conventional material;

FIG. 9 is a photograph of setters formed from silicate materials, according to one or more embodiments described herein;

FIG. 10 is a photograph of the setters shown in FIG. 9 on a stainless steel annealing lehr and glass vials placed on the setters, according to one or more embodiments described herein;

FIG. 11 is a photograph of a control glass vial after being placed directly on the stainless steel annealing lehr shown in FIG. 10, processed, and thermally shocked;

FIG. 12 is a photograph of a glass vial after being placed on the setters as shown in FIG. 10, processed, and thermally shocked;

FIG. 13 is a photograph of the glass vial shown in FIG. 12 after residue removal;

FIG. 14 is a photograph of a glass vial after being placed on the setters as shown in FIG. 10, processed, and thermally shocked;

FIG. 15 is a photograph of the glass vial shown in FIG. 14 after residue removal;

FIGS. 16A, 16B, and 16C are the SEM/EDX line scans of a silicate material, according to one or more embodiments described herein, after being placed in a salt bath;

FIGS. 17A, 17B, and 17C are the SEM/EDX line scans of a silicate material, according to one or more embodiments described herein, after being placed in a salt bath;

FIG. 18 is a plot of phase percentage vs. temperature of the decomposition of a silicate material, according to one or more embodiments described herein;

FIG. 19 is a photograph of plaques formed from silicate materials, according to one or more embodiments described herein, with glass sheets thereon;

FIG. 20 is a photograph of the plaques shown in FIG. 19 after being subjected to an adhesion test;

FIG. 21 is a photograph of pellets formed from silicate materials, according to one or more embodiments described herein, with glass sheets thereon; and

FIG. 22 is a photograph of the pellets shown in FIG. 21 after being subjected to an adhesion test.

### DETAILED DESCRIPTION

Reference will now be made in detail to various embodiments of apparatuses for holding glassware during processing to mitigate glass damage. According to embodiments, an apparatus for holding glassware during processing includes a plurality of ware keepers, each ware keeper configured to receive a piece of glassware during the processing. Each ware keeper comprises a glass contact surface comprising a silicate material having a Knoop hardness less than or equal to 400 HK₂₀₀ and a specific gravity greater than or equal to 1.5 and less than or equal to 6. Various embodiments of apparatuses for holding glassware will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply ab solute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “scratch parameter,” as used herein, refers to a maximum depth in microns (μm) of a flaw in a piece of glassware caused by the glass contact surface contacting the piece of glassware at an applied force less than or equal to 45N. The scratch is created using a Nanovea M1 Scratch and Hardness Tester. The maximum depth is measured by fractography in accordance with ASTM C149-14.

Adhesion, as used herein, is measured in accordance with an adhesion test by modifying ASTM G219-18: Standard Guide for Determination of Static Coefficient of Friction of Test Couples Using an Inclined Plane Testing Device. Specifically, this guide is intended to standardize the use of an inclined plane testing device to measure the breakaway friction (i.e., static) coefficient of mating couples that are of such size and shape that they may be made into a rider (i.e., one member of the sliding couple) on a flat plane (i.e., the second member of the sliding couple) that may be inclined at an angle to produce motion of the rider. The glass contact surface comprising a silicate material in accordance with embodiments described herein is the “flat plane” described in Section 6.4.1 of ASTM G219-18. A flat sheet of a glass having a softening point above 850° C. and the dimensions 2.54 cm long×2.54 cm wide×0.4-1.5 mm thick is the “rider” described in Section 6.4.1 of ASTM G219-18. The rider is placed on top of the flat plane and placed in a furnace at an exposure temperature (e.g. 750° C.) for 24 hours. After 24 hours, the flat plane and rider are removed from the furnace and cooled to room temperature. Then, the flat plane is inclined up to 80° (i.e., “breakaway angle” as defined in Section 8.3 of ASTM G219-18). The rider is considered to “adhere” to the flat plane if the rider does not break away from the flat plane with the flat plane inclined at 80°. The rider is considered to “not adhere” if the rider beaks away from the flat plane at an incline less than 80°.

The term “coefficient of friction,” as used herein, is measured according to ASTM E384-10.

Knoop Hardness, as described herein, is measured according to ASTM E384-10. HK₂₀₀, as described herein, are the units used to for Knoop Hardness measured with a 200 gram indenter.

Specific gravity, as described herein, is measured according to IEC 60371-2 for mica and according to ASTM D854-92 for other material described herein.

Scanning Electron Microscope (SEM) scan lines, as described herein, are obtained using a JEOL Model 6610. The conditions are 20 kV at magnification 30× to 1,000× and approximately 10 mm working distance.

Energy Dispersive X-Ray Analyzed (EDX) scan lines, as described herein, are obtained using an Oxford 50 mm² XMAX EDX Detector. The conditions are 20 kV at 10 mm working distance.

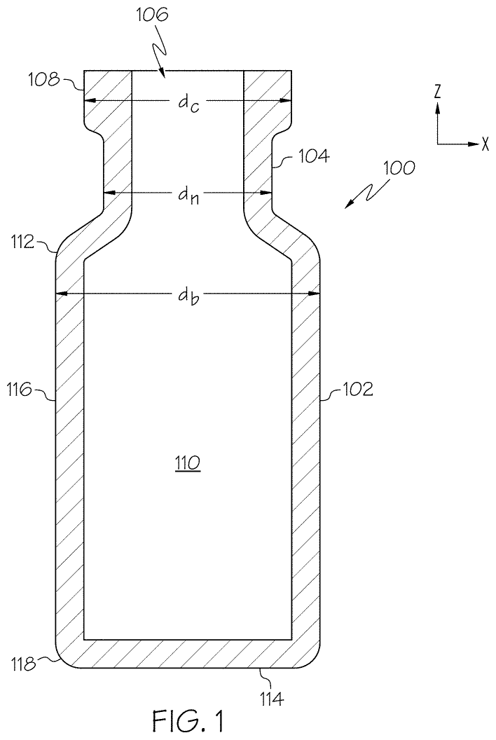

Glassware is used in a variety of applications, including packaging of food, beverages, and pharmaceuticals. Referring now to FIG. 1, an exemplary piece of glassware 100 in the form of a glass vial is depicted. The piece of glassware 100 includes a body section 102, a neck section 104 above the body section 102, and an opening 106 leading through the neck section 104 and connected to the interior volume 110. The body section 102 substantially surrounds the interior volume 110 of the piece of glassware 100 with a bottom section 114 and side walls 116. The neck section 104 generally connects the body section 102 with the opening 106. The opening 106 may be surrounded by a collar 108 extending outward from the top of the neck section 104 of the piece of glassware 100. The body section 102 may have a curved bottom edge 118 and a curved area 112 adjacent the neck section 104. Generally, the neck section 104, body section 102, and collar 108 may have a generally circular shaped cross section, each comprising an exterior diameter. In embodiments, the diameter of the collar (dc in FIG. 1) is greater than the diameter of the neck section (dn in FIG. 1) and the diameter of the body section (db in FIG. 1) is greater than the diameter of the collar 108. The neck section 104 and collar 108 may generally be formed with a greater thickness than the balance of the piece of glassware 100 and, as such, may be better able to withstand incidental damage, such as scuffing, scratching or the like, without breakage than the balance of the piece of glassware 100.

The breakage of glassware during processing and/or filling due to damage is a source of product loss and may lead to process inefficiencies and increased costs. Strengthening of glassware may assist in mitigating breakage. Glassware may be strengthened using a variety of techniques, including chemical and thermal tempering.

In embodiments, chemical tempering (i.e., ion exchange) may be used to strengthen glassware through the introduction of a layer of compressive stress in the surface of the glassware. The compressive stress is introduced by submerging the glassware in a molten salt bath. As ions from the glass are replaced by relatively larger ions from the molten salt, a compressive stress is induced in the surface of the glass. During chemical tempering, glassware, such as glass containers, may be mechanically manipulated to both fill and empty the glassware of molten salt.

In embodiments, thermal tempering (i.e., annealing) may be used to strengthen glassware through slowly cooling the hot glassware to relieve internal stress once it has been formed. During the manufacturing process, the glassware is heated until the temperature reaches the annealing point, which is the stress relief point glass reaches during the cool down phase. At this point, the glassware is too firm to distort, but remains soft enough for any built up stresses to relax. Holding the piece of glassware at this temperature helps to even out the temperature throughout the piece of glassware. The holding time may depend on the composition of the piece of glassware. Once the hold time has lapsed, the annealed piece of glassware is slowly cooled through the strain point.

Various conventional apparatuses for holding glassware during processing such as chemical and thermal tempering are known, such as standard mesh belt, a PENNEKAMP stainless steel annealing lehr, or a HOFFMAN lehr belt. These conventional apparatuses are primarily formed from steel, in particular stainless steel.

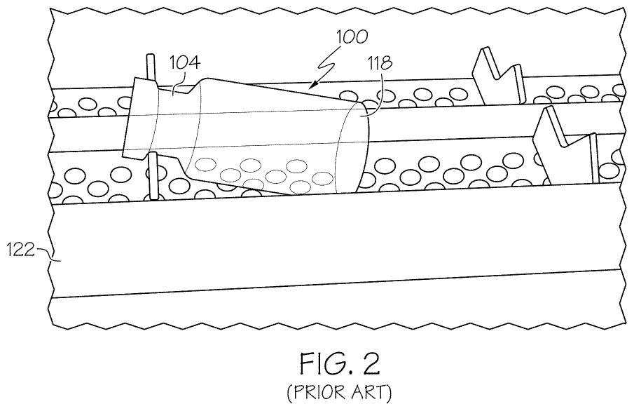

Despite careful handling during loading and unloading of the glassware on and off these conventional apparatuses, damage still occurs during processing (e.g., chemical and thermal tempering) due to the contact between the glassware and stainless steel. For example, as shown in FIG. 2, the neck section 104 and the curved bottom edge 118 of the piece of glassware 100 are vulnerable to damage from contacting the stainless steel of a PENNEKAMP stainless steel annealing lehr 122. Although the hardness of stainless steel is less than glass, the COF is sufficient to transfer metal to the vial and damage the glassware. Additionally, during chemical tempering, stainless steel oxidizes in the salt to form a yellow/brown colored material rich in chrome oxide. The oxide may be considered a protective layer to the magazine. However, the oxide may be transferred to the glassware as a source of contamination.

Disclosed herein are glass contact surfaces which mitigate the aforementioned problems. Specifically, the glass contact surfaces disclosed herein comprise silicate materials having a relatively low Knoop hardness and specific gravity, which mitigate glassware damage. In particular, contacting the glassware with silicate materials described herein during processing may result in light cosmetic scratching as opposed to the frictive checking observed with stainless steel to glassware contact. Moreover, silicate materials described herein may be chemically inert in the salt bath environment of chemical tempering and may not leach byproducts into the salt bath. Even replacing only a portion of the stainless steel components of conventional apparatuses with the silicate materials described herein will help to reduce the amount of chromium leached into the salt bath, which increases product quality and reduces environmental impact. Furthermore, silicate materials described herein may be functionally unaffected by the elevated temperatures of thermal tempering such that the glassware does not stick to the silicate materials after thermal tempering.

The silicate materials described herein may be generally described as having a Knoop hardness less than or equal to 400 HK₂₀₀ and a specific gravity greater than or equal to 1.5 and less than or equal to 6. To mitigate or prevent damage to glassware during processing, it may be desirable to select a material having a relatively low hardness/high softness and a slippery, greasy feel to form the glass contact surface. In embodiments, the silicate materials described herein may be relatively soft, as indicated by a Knoop hardness less than or equal to 400 HK₂₀₀ as compared to metals such as stainless steel, which have a Knoop hardness of approximately 425 HK₂₀₀. In embodiments, the silicate materials may have a Knoop hardness less than or equal to 400 HK₂₀₀, less than or equal to 375 HK₂₀₀, less than or equal to 350 HK₂₀₀, less than or equal to 325 HK₂₀₀, less than or equal to 300 HK₂₀₀, less than or equal to 250 HK₂₀₀, or even less than or equal to 200 HK₂₀₀. In embodiments, the silicate materials may have a slippery, greasy feel, as indicated by a specific gravity greater than or equal to 1.5 and less than or equal to 6. For the sake of comparison, stainless steel has a specific gravity of 7.9. In embodiments, the silicate materials may have a specific gravity greater than or equal to 1.5, greater than or equal to 2, greater than or equal to 2.5, or even greater than or equal to 3. In embodiments, the silicate materials may have a specific gravity less than or equal to 6, less than or equal to 5.5, less than or equal to 5, less than or equal to 4.5, or even less than or equal to 4. In embodiments, the silicate material may have a specific gravity greater than or equal to 1.5 and less than or equal to 6, greater than or equal to 1.5 and less than or equal to 5.5, greater than or equal to 1.5 and less than or equal to 5, greater than or equal to 1.5 and less than or equal to 4.5, greater than or equal to 1.5 and less than or equal to 4, greater than or equal to 2 and less than or equal to 6, greater than or equal to 2 and less than or equal to 5.5, greater than or equal to 2 and less than or equal to 5, greater than or equal to 2 and less than or equal to 4.5, greater than or equal to 2 and less than or equal to 4, greater than or equal to 2.5 and less than or equal to 6, greater than or equal to 2.5 and less than or equal to 5.5, greater than or equal to 2.5 and less than or equal to 5, greater than or equal to 2.5 and less than or equal to 4.5, greater than or equal to 2.5 and less than or equal to 4, greater than or equal to 3 and less than or equal to 6, greater than or equal to 3 and less than or equal to 5.5, greater than or equal to 3 and less than or equal to 5, greater than or equal to 3 and less than or equal to 4.5, or even greater than or equal to 3 and less than or equal to 4, or any and all sub-ranges formed from any of these endpoints.

In embodiments, the silicate material may comprise a phyllosilicate mineral.

Phyllosilicate minerals have parallel sheets of silicate tetrahedra with SiO₅, represented by the chemical formula [Si₂ₙO₅ₙ]²ⁿ⁻. Phyllosilicate minerals are generally soft and have relatively low specific gravity. In embodiments, the phyllosilicate mineral may comprise talc, mica, or a combination thereof. Talc has the chemical formula Mg₃Si₄O₁₀(OH)₂. In embodiments, the talc may have a compositional content of 63.37 wt % SiO₂, 31.88 wt % MgO, and 4.75 wt % H₂O. In embodiments, talc is in the form of soapstone. In embodiments, the soapstone is natural soapstone or synthetic soapstone. Mica may be represented by the following general formula:

X₂Y₄₋₆Z₈O₂₀(OH,F)₄

in which X is K, Na, Ca, Ba, Rb, or Cs; Y is Al, Mg, Fe, Mn, Cr, Ti, or Li; and Z is Si, Al, Fe³⁺ or Ti.

In embodiments, the silicate material may comprise a tectosilicate mineral. Tectosilicate minerals have a three-dimensional framework of silicate tetrahedral with SiO₂, represented by the chemical formula [AlₓSi_{y}O_{(2x+2y)}]^{x-}. In embodiments, the tectosilicate mineral comprises quartz, feldspar, feldspathoid, or a combination thereof. In embodiments, the feldspar comprises microcline (KAlSi₃O₈), albite (NaAlSi₃O₈), sanidine (KAlSi₃O₈), othroclase (KAlSi₃O₈), labradorite ((Ca,Na)(Si,A₁)₄O₈), anorthite (CaAl₂Si₂O₈), or a combination thereof.

In embodiments, the silicate materials described herein, when used to form a glass contact surface, may reduce the amount and depth of flaws in the glassware produced during processing. In embodiments, the use of the silicate materials as a glass contact surface may result in light cosmetic scratching as opposed to the frictive checking observed with stainless steel to glassware contact. Accordingly, in embodiments, the use of the silicate material as a glass contact surface may limit the scratch parameter and the coefficient of friction of the glass contact surface with respect to glassware contacting the glass contact surface.

In embodiments, the glass contact surface may have a scratch parameter less than or equal to 75 μm with respect to the glassware contacting the glass contact surface as measured at an applied force less than or equal to 45 N. In embodiments, the glass contact surface may have a scratch parameter less than or equal to 75 μm, less than or equal to 70 μm, less than or equal to 65 μm, less than or equal to 60 μm, less than or equal to 55 μm, or even less than or equal to 50 μm with respect to the glassware contacting the glass contact surface as measured at an applied force less than or equal to 45 N.

In embodiments, the glass contact surface may have a coefficient of friction less than or equal to 0.5 with respect to the glassware as measured at an applied force less than or equal to 45 N. In embodiments, the glass contact surface may have a coefficient of friction less than 0.5, less than or equal to 0.45, less than or equal to 0.4, less than or equal to 0.35, or even less than or equal to 0.3 as measured at an applied force less than or equal to 45 N.

The silicate materials described herein, when used to form a glass contact surface, may be subjected to increased temperatures, such as during thermal tempering. Accordingly, in embodiments, it may be desirable that the silicate materials do not adhere to the glassware contacting the glass contact surface when exposed to increased temperatures and thereafter. In embodiments, the silicate materials do not adhere to the glassware contacting surface after exposure to a temperature (i.e., exposure temperature) less than or equal to 750° C. for 24 hours. In embodiments, the silicate materials do not adhere to the glassware contacting surface after exposure to a temperature less than or equal to 750° C., less than or equal to 700° C., less than or equal to 650° C., less than or equal to 600° C., less than or equal to 550° C., or even less than or equal to 500° C. for 24 hours.

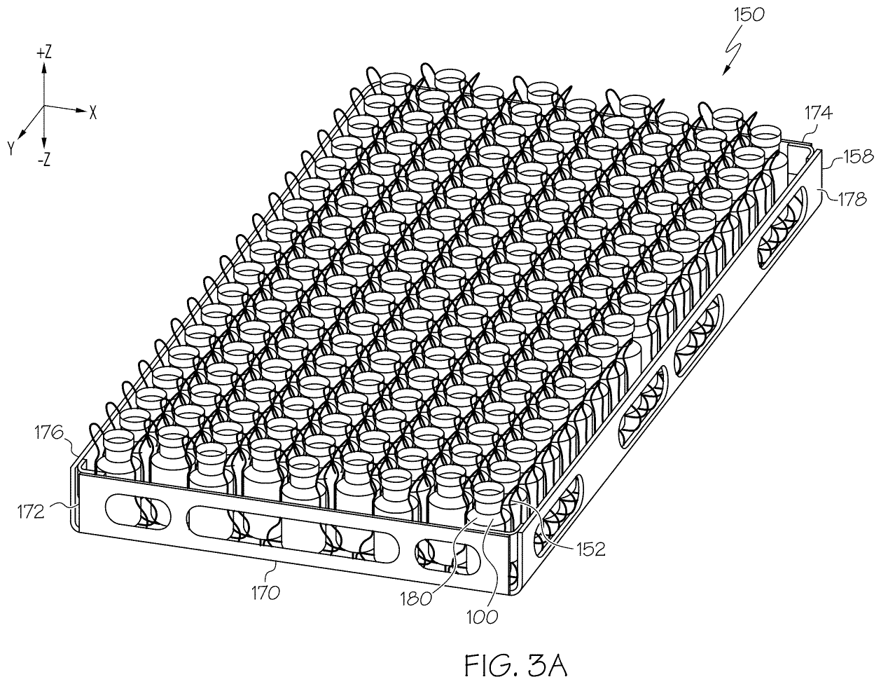

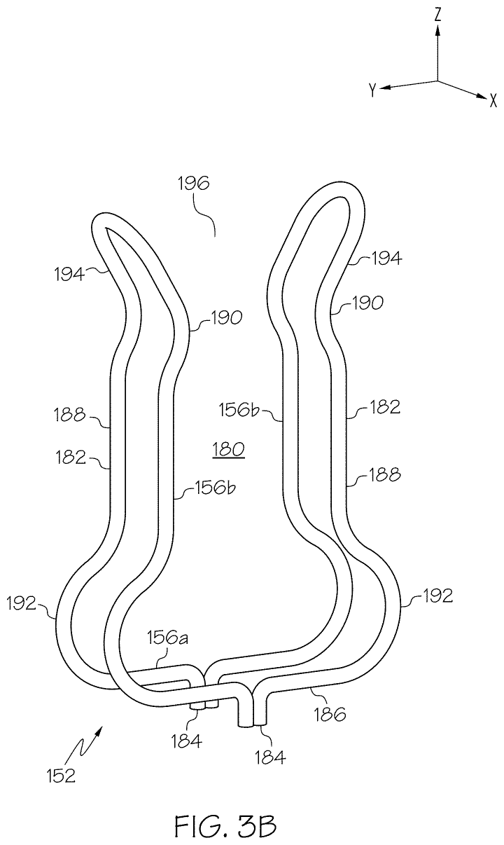

Referring now to FIGS. 3A and 3B, an embodiment of an apparatus 150 for holding glassware during processing is depicted. The apparatus 150 includes a plurality of ware keepers 152. Each ware keeper 152 is configured to receive a piece of glassware 100 during processing. Each ware keeper 152 comprises a glass contact surface 156a, 156b comprising a silicate material as described herein such that damage to the glassware 100 during processing is limited.

The apparatus 150 may include a base frame 158. In embodiments, the base frame 158 may be formed from a material capable of withstanding elevated temperatures, such as the temperatures experienced in a molten salt bath during ion exchange. In embodiments, the base frame 158 may be formed from a metallic material, such as stainless steel or other like metal or metal alloy. In embodiments, the base frame 158 may be formed from the silicate materials described herein.

The base frame 158 may generally include a bottom support plate 170 and may also include side members 172, 174, 176, and 178. The bottom support plate 170 may be tray shaped (such as generally rectangular as shown in FIG. 3A) and support the plurality of ware keepers 152. The side members 172, 174, 176, and 178 may be located on edges of the base frame 158. The side members 172, 174, 176, and 178 may be integrally formed with the bottom support plate 170 or attached to the bottom support plate 170 using conventional fastening techniques including without limitation, mechanical fasteners, welding, or the like.

Each ware keeper 152 may extend from the base frame 158 and defines and circumscribes a glassware receiving volume 180 in which the piece of glassware 100 is received and retained. The glass contact surface 156a, 156b may be positioned within the glassware receiving volume 160. The plurality of ware keepers 152 may be arrayed in a linear array as shown in FIG. 3A.

Each ware keeper 152 may be shaped and sized to securely retain a piece of glassware 100. For example, in embodiments, as shown in FIG. 3B, the ware keeper 152 may include retention bodies 182 which are positioned within the glassware receiving volume 180. The retention bodies 182 are discrete, independent structures positioned on opposite sides of the glassware receiving volume 180 such that the retention bodies 182 may be positioned on either side of the piece of glassware 100 positioned in the in the glassware receiving volume 180, thereby securing the piece of glassware 100 in the glassware receiving volume 180. Each retention body 182 includes a base connection stem 184, a seat segment 186, a body segment 188, a retention segment 190, a lower segment 192, and a lever segment 194. The retention bodies 182 may be positioned on opposite sides of the glassware receiving volume 180 where the piece of glassware may be held.

The base connection stem 184 may be positioned proximate a bottom section 114 (FIG. 1) of a held piece of glassware 100. The base connection stem 184 may support the other portions of the retention body 182 and may be affixed to the base frame 158 such that it is engaged with the bottom support plate 170. The base connection stem 184 may emanate from the bottom support plate 170, below the glassware receiving volume 180. In embodiments, the base connection stem 184 may form about a 90° angle with the bottom support plate 170.

The base connection stem 184 is attached to the seat segment 186. The seat segment 186 may be contiguous with the base connection stem 184 and be positioned over and substantially parallel to the bottom support plate 170. The seat segments 186 generally form a glass contact surface 156a in the form of a glassware seat positioned above and substantially parallel to the bottom support plate 170. The glass contact surface 156a may define the bottom of the glassware receiving volume 180. The spacing between the bottom support plate 170 may be sufficient to allow for the flow of a fluid beneath a held piece of glassware 100, such that the bottom section 114 (FIG. 1) of a piece of glassware 100 held in the glassware receiving volume 180 may be contacted by the fluid. In embodiments, the seat segments 186 of adjacent retention bodies 182 are parallel, such that they form a flat surface.

The seat segment 186 may be attached to a lower segment 192 of the retention body 182. The lower segment 192 may be shaped to form a protruded area in the glassware receiving volume 180. The diameter of the glassware receiving volume 180 enclosed by the lower segment 192 may be greater than the diameter of the glassware receiving volume 180 enclosed by the body segment 188. For example, the lower segment 192 may be convexed shaped relative to the glassware receiving volume 180. The lower segment 192 may be shaped such that it avoids contact with a curved bottom edge 118 (FIG. 1) of the piece of glassware 100 held in the glassware receiving volume 180. It may be desirable to avoid contact by the ware keepers 152 with the curved bottom edge 118 of the piece of glassware 100 because scratches or other damage at the curved bottom edge 118, which may be caused by contact with the ware keepers 152 in that region, may be undesirable relative to other areas of the pieces of glassware 100 because the curved bottom edge 118 of the piece of glassware 100 may be an area of high stress when vertical pressure is applied to the piece of glassware 100. However, in embodiments, the seat segment 186 may be coupled directly to the body segment 188.

The lower segment 192 may be attached to a body segment 188 of the retention body 182. The body segment 188 may extend away from the bottom support plate 170 and, in embodiments, may be substantially perpendicular to the bottom support plate 170. As shown in FIG. 3B, the body segment 188 may be substantially straight and contoured with a side wall 116 (FIG. 1) of the piece of glassware 100 held in the glassware receiving volume 180. The body segment 188 may form the glass contact surface 156b in the form of a basket or cage like configuration which restrain the motions of the piece of glassware 100 in the horizontal direction, defined by the direction of the X-Y plane.

The body segment 188 is attached to a retention segment 190 of the retention body 182. The retention segment 190 may generally be shaped to form a recessed area in the glassware receiving volume 180. The diameter of the glassware receiving volume 180 enclosed by the retention segment 190 may be less than the diameter of the glassware receiving volume 180 enclosed by the body segment 188. For example, the recessed area may be recessed relative to the piece of glassware 100 held in the glassware receiving volume 180. The retention segment 190 may be concave shaped relative to the glassware receiving volume 180. For example, the retention segment 190 may be contoured to the shape of a neck section 104 (FIG. 1) and a curved area 112 (FIG. 1) adjacent to the neck section 104. The distance between retention segments 190 of each retention body 182 may be greater than the diameter of the neck section 104 of the held piece of glassware 100. As such, the glassware 100 are secured by the ware keepers 152 in the glassware receiving volume 180 such that the glassware 100 are limited in vertical movement, defined by the direction of the Z-axis. For example, when a piece of glassware 100 is turned upside down relative to its position in FIG. 3A, the retention segment 190 will contact the curved area 112 of the piece of glassware and be retained in the glassware receiving volume 180.

The retention segment 190 may be coupled to a lever segment 194. The lever segment 194 may generally extend away from the bottom support plate 170 and the lever segments 194 of opposing retention bodies 182 may extend away from one another.

It should be understood that the ware keepers 152 described herein are not limited to those comprising retention bodies 182. In embodiments, various numbers of retention bodies 182 may be utilized.

The plurality of ware keepers 152 may comprise a plurality of receiving slots 196. Each receiving slot 196 may receiving a portion of the piece of glassware 100. The receiving slots 196 may be arrayed in a linear array as shown in FIG. 3A.

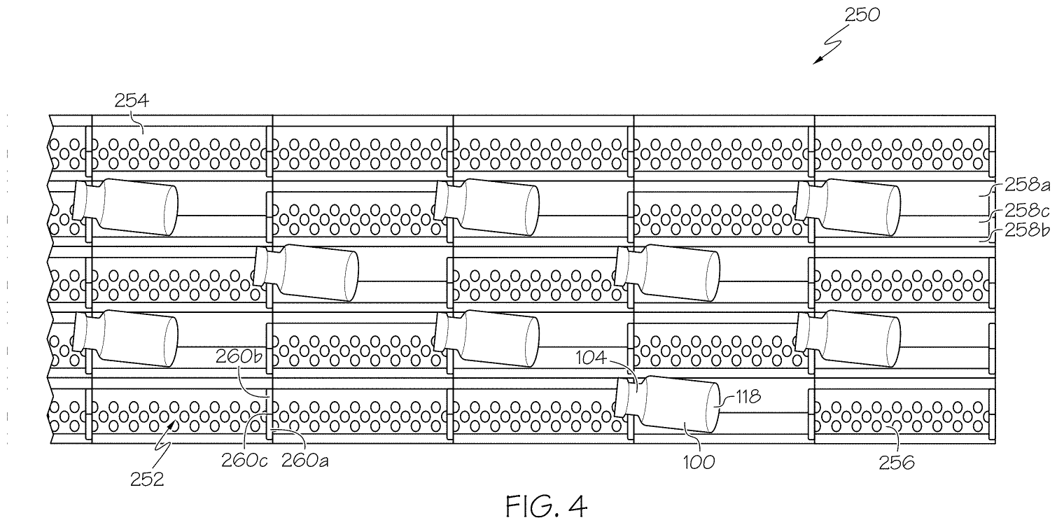

Referring now to FIG. 4, another exemplary apparatus for holding glassware during processing is shown at 250. The apparatus 250 includes a conveyor belt 252 comprising a plurality of metal laths 254. The plurality of ware keepers 256 are positioned on the conveyor belt 252 such that pairs of glass contact surfaces 258a, 258b, 260a, 260b form glassware receiving slots 258c, 260c on the conveyor belt 252. When the piece of glassware 100 is disposed on the conveyor belt 252 within the glassware receiving slots 258c, 260c, the piece of glassware 100 is exclusively contacted by the pairs of glass contact surfaces 258a, 258b, 260a, 260b. As shown in FIG. 4, the glassware receiving slots 258c, 260c may be V-shaped. The glass contact surfaces 258a, 258b, 260a, 260b forming the glassware receiving slots 258c, 260c are configured to contact at least one of a curved bottom edge 118 or a neck section 104 of the piece of glassware 100. For example, glass contact surfaces 258a, 258b form a glassware receiving slot 258c that contacts a curved bottom edge 118 of the piece of glassware 100. Glass contact surfaces 260a, 260b form a glassware receiving slot 260c that contacts a neck section 104 of the piece of glassware 100. In embodiments, at least one of the pairs of glass contact surfaces 258a, 258b and 260a, 260b are made of a silicate material. In embodiments, at least one of the pairs of glass contact surfaces 258a, 258b and 260a, 260b is formed integrally with the conveyor belt 252. In embodiments, at least one of the pairs of glass contact surfaces 258a, 258b and 260a, 260b are setters or inserts made from silicate materials that are placed on or secured to the conveyor belt 252.

In embodiments, the structure of the apparatus and the silicate material used to form a glass contact surface of the apparatus may depend on the type of processing being performed. In embodiments, the processing is ion exchange processing and the silicate material used to form the glass contact surface is feldspar. In embodiments, the processing is annealing and the silicate material used to form the glass contact surface is talc, mica, or a combination thereof.

Although various embodiments are described herein with reference to the apparatus, it should be understood that embodiments of the glass contact surface including a silicate material as described herein may be used with a variety of apparatuses that are known and used by those skilled in the art. In particular, chemical tempering and thermal tempering may be accomplished using a number of different apparatuses having a number of different structures.

### EXAMPLES

In order that various embodiments be more readily understood, reference is made to the following examples, which are intended to illustrate various embodiments of the glass contact surfaces described herein.

### Example 1: Scratch Test

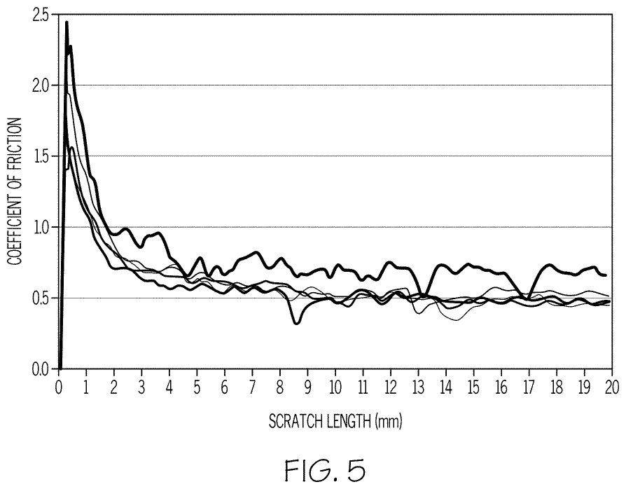

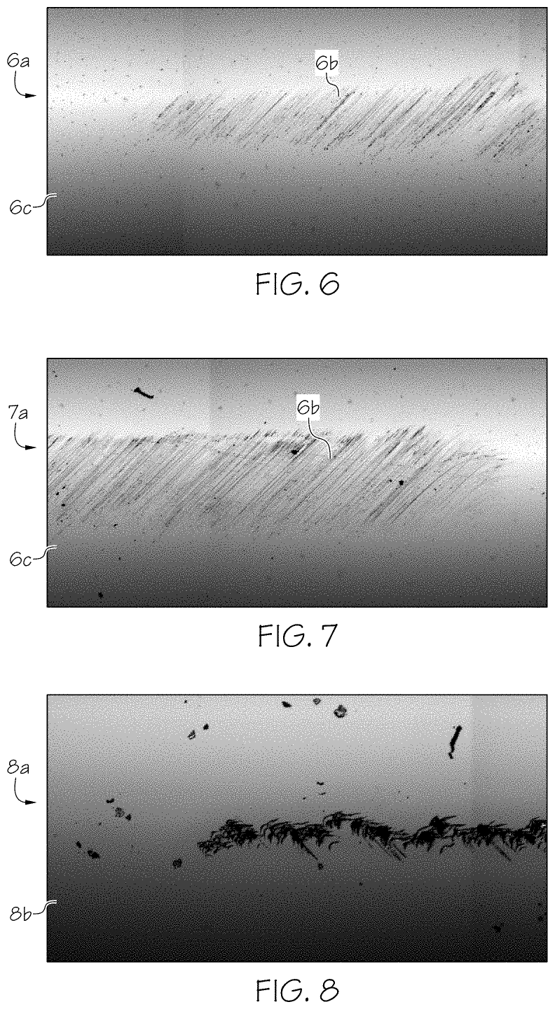

To evaluate the damage introduction mechanism resulting from a glass contact surface formed from a silicate material as described herein with respect to glassware contacting the glass contact surface, a scratch test was conducted on 5 glass vials where a feldspar cylinder having a 16.75 mm outer diameter was scratched across a glass vial having a 16.75 mm outer diameter. The force at which the feldspar cylinder was applied to the glass vial was ramped from 1 N to 45 N at a rate of 1 mm/s. Referring now to FIG. 5, after the static friction was overcome, as evidenced by the sharp decrease in the COF at approximately 0.5 mm along the scratch path, the dynamic friction was lower than 0.7, which is the coefficient of friction required for glassware damage introduction. Referring now to FIG. 6, the initial portion 6a of the scratch 6b generated by applying the feldspar cylinder to a glass vial 6c showed no severe damage from overcoming the static friction. Referring now to FIG. 7, the end portion 7a of the scratch 6b generated by applying the feldspar cylinder to the glass vial 6c showed no severe damage at the highest scratch load of 45 N.

As a comparison, a scratch test was conducted where a stainless steel cylinder having a 16.75 mm outer diameter was scratched across a glass vial having a 16.75 mm outer diameter using the same experimental conditions as described above. The force at which the stainless steel cylinder was applied to the glass vial was ramped from 1 N to 15 N at a rate of 1 mm/s. Referring now to FIG. 8, a scratch 8a generated by applying the stainless steel cylinder to the glass vial 8b showed severe frictive checking. As indicated by Example 1, contacting the glassware with silicate materials described herein during processing resulted in light cosmetic scratching as opposed to the frictive checking observed with stainless steel to glassware contact.

### Example 2: Thermal Shock Test

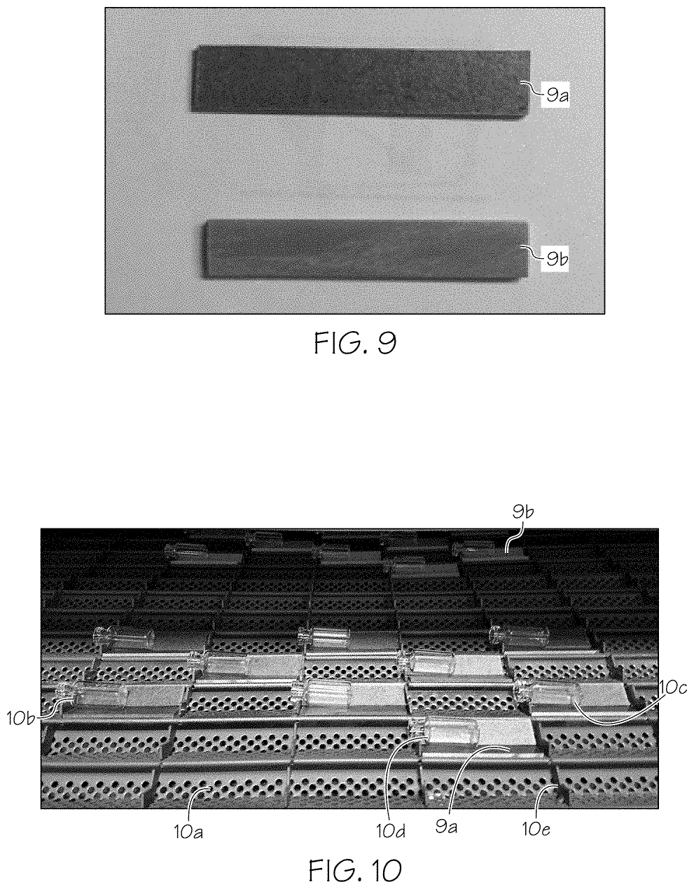

Referring now to FIG. 9, mica setters 9a and soapstone (i.e., talc) setters 9b were fabricated to be 3 mm thick. Referring now to FIG. 10, portions of a PENNEKAMP stainless steel annealing lehr 10a were lined with the mica setters 9a and soapstone setters 9b. 100 glass vials 10b were hand loaded and supported at the curved bottom edge 10c of the glass vials 10b by the mica setters 9a or the soapstone setters 9b. The neck region 10d of the glass vials 10b was supported by the stainless steel V-groove 10e of the PENNEKAMP stainless steel annealing lehr 10a. 50 additional glass vials (control) were placed directly on the PENNEKAMP stainless steel annealing lehr 10a. The glass vials were subjected to a lehr cycle in a furnace of 1 hour with a maximum temperature of 620° C. The glass vials were then removed from the furnace and thermally shocked using a progressive thermal shock method. In particular, 50 vials were placed in an oven at 190° C. for 20 minutes. The vials were then quenched (i.e., thermally shocked) in water at room temperature. The vials were inspected for breakage using a reflective optical microscope. The same vials that did not break were placed back in the oven in 20° C. increments up to 250° C. and the same quenching procedure was followed to verify breakage.

TABLE 1

| | | | | |
|---|---|---|---|---|
| | | | | Cumulative % |
| Oven temp. | # breaks | # shocked | % breaks | breaks |

Control glass vials directly on stainless steel

| | | | | |
|---|---|---|---|---|
| 190 | 0 | 50 | 0 | 0 |
| 210 | 1 | 50 | 2 | 2 |
| 230 | 0 | 49 | 0 | 0 |
| 250 | 13 | 48 | 27 | 26 |

Glass vials on soap stone setters

| | | | | |
|---|---|---|---|---|
| 190 | 0 | 50 | 0 | 0 |
| 210 | 0 | 50 | 0 | 0 |
| 230 | 0 | 50 | 0 | 0 |
| 250 | 0 | 50 | 0 | 0 |

Glass vials on mica board setters

| | | | | |
|---|---|---|---|---|
| 190 | 0 | 48 | 0 | 0 |
| 210 | 0 | 48 | 0 | 0 |
| 230 | 1 | 48 | 2 | 2 |
| 250 | 0 | 47 | 0 | 0 |

The control glass vials had a 27% failure rate total. The glass vials placed on the soapstone setters had a 0% failure rate and the glass vials placed on the mica setters had a 2% failure rate. As indicated by the results of the thermal shock test shown in Table 1, glass contact surfaces formed from silicate materials as described herein showed a significant improvement in mitigating damage over the standard stainless steel lehr.

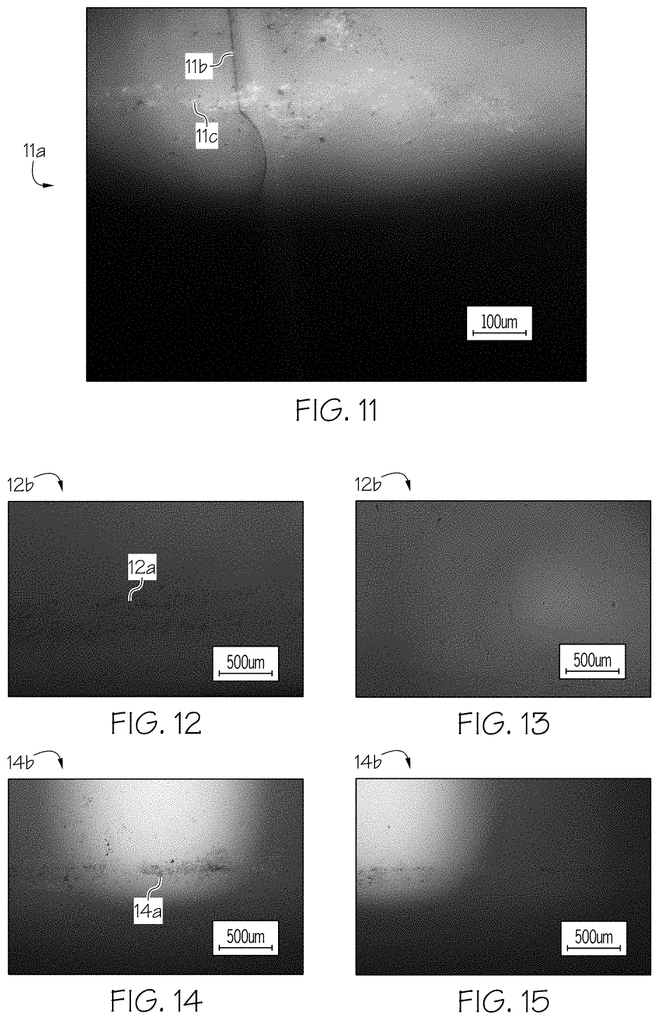

Referring now to FIG. 11, not only did control glass vials 11a fail as evidenced by the circumferential metal scratch 11b at the break source, microscopic analysis showed a circumferential metallic residue 11c (bright contrast phase in the figure) on the curved bottom edge of the vial 11a. This metallic residue 11c was not removable using isopropyl alcohol. As indicated by the metallic residue 11c shown in FIG. 11, the stainless steel of the standard stainless steel lehr transferred to the glass vial 11a and could not be removed, thereby further damaging the glass vial 11a.

Referring now to FIG. 12, visual analysis showed circumferential mica residue 12a on the curved bottom edge of the glass vial 12b. The mica residue 12a was removed using isopropyl alcohol as evidenced by the lack of mica residue 12a in FIG. 13. As indicated by FIGS. 12 and 13, although mica from the mica setter transferred to the glass vial 12b, the mica residue 12a was easily removed and, therefore, did not alter the glass vial 12b. Accordingly, the mica setter showed improvement in mitigating damage over the standard stainless steel lehr.

Referring now to FIG. 14, microscopic analysis showed a circumferential soapstone residue 14a on the curved bottom edge of the glass vial 14b. The circumferential soapstone residue 14a was removed using isopropyl alcohol as evidenced by the lack of soapstone residue 14a in FIG. 15. As indicated by FIGS. 14 and 15, although soapstone from the soapstone setter transferred to the glass vial 14b, the soapstone residue 14a was easily removed and, therefore, did not alter the glass vial 14b. Accordingly, the soapstone setter showed improvement in mitigating damage over the standard stainless steel lehr.

### Example 3: Ion Exchange Test

Table 2 below shows the compositional content, in wt %, of microcline and albite.

TABLE 2

| Oxide (wt %) | Microcline | Albite |
|---|---|---|
| SiO₂ | 64.76 | 67.39 |
| Al₂O₃ | 18.32 | 20.35 |
| Na₂O | — | 11.19 |
| K₂O | 16.92 | — |
| CaO | — | 1.07 |

1 μm thick polished blocks of microcline and albite were formed and placed in a molten KNO₃ salt bath at 445° C. for 12 hours.

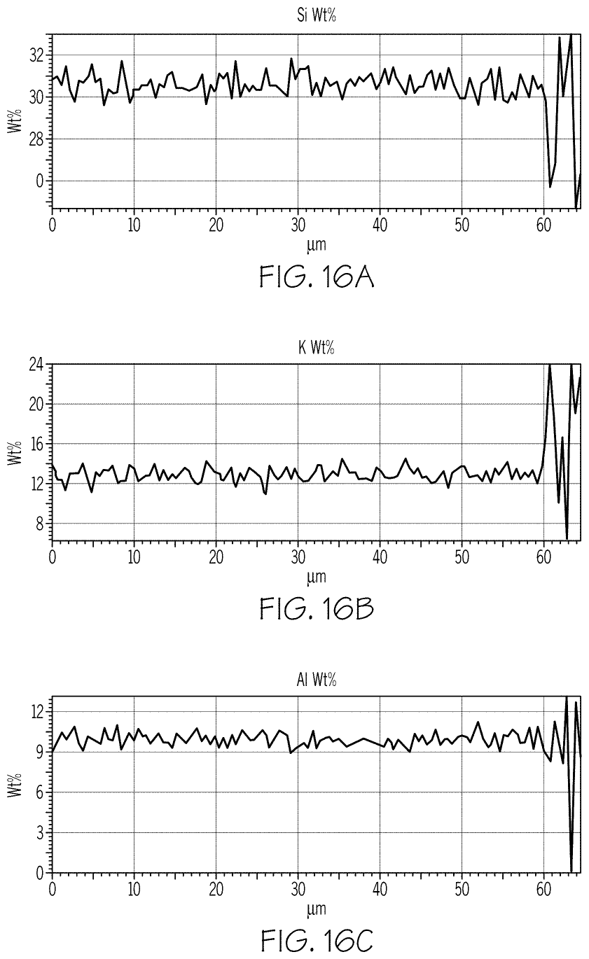

Referring now to FIGS. 16(A), 16(B), and 16(C), the SEM/EDX line scans following exposure to the salt bath showed no evidence that ion exchange occurred in the microcline block after placing the microcline block in the molten salt bath. In particular, the amount of potassium observed in the block did not sharply increase after being placed in the molten salt bath. Note that the feature at approximately 60 μm is the epoxy/microcline interface.

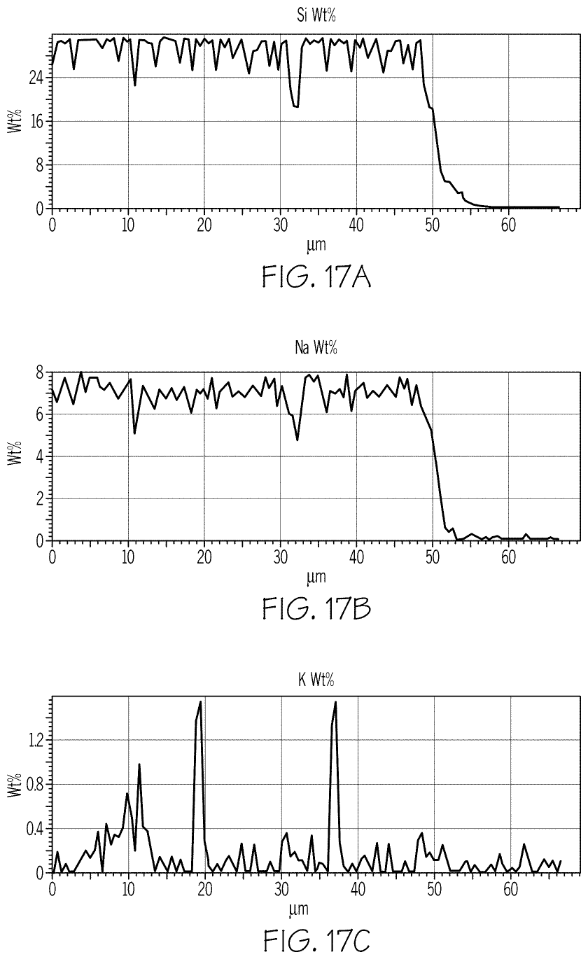

Referring now to FIGS. 17(A), 17(B), and 17(C), the SEM/EDX line scans following exposure to the salt bath showed no evidence that ion exchange occurred in the albite block after placing the albite block in the molten salt bath. In particular, the amount of potassium observed in the block did not sharply increase after being placed in a molten salt bath. The elevated peaks in the potassium line scan shown in FIG. 17(C) may be attributed to albite having microcline in the bulk specimen and is not related to the molten salt bath.

As indicated by Example 3, subjecting microcline and ablite to a molten salt bath did not result in ion exchange of the microcline and albite. While not wishing to be bound by theory, it is believed that silicate materials such as microcline and ablite are chemically inert in the salt bath environment of chemical tempering and may not leach byproducts in the salt bath that would effect the glassware being processed.

### Example 4: Adhesion Test of Natural Soapstone, Mica, and Synthetic Soapstone

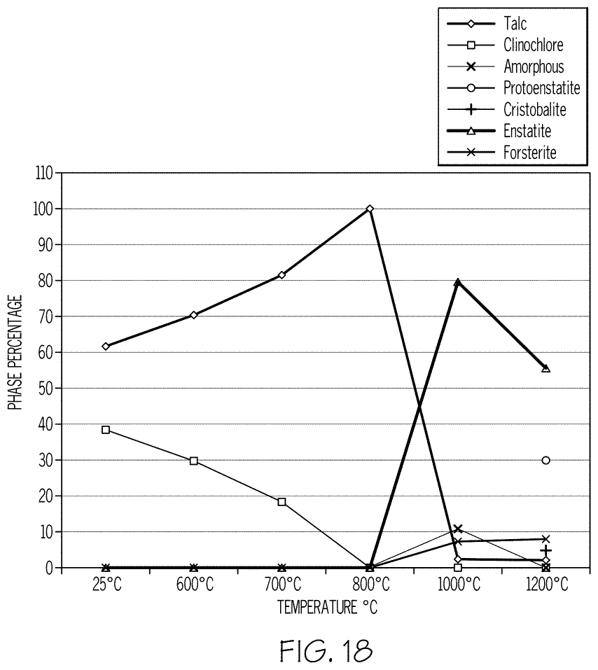

Referring now to FIG. 18, heat treating natural soapstone decomposes and changes the phase mineralogy of the natural soapstone. For example, XRD results showed degradation of clinocholore in the natural soapstone to 100% talc in the natural soapstone after heat treatment at 800° C. for a period of 24 hours. The glass adhesion tests described below were conducted on natural soapstone after the natural soapstone was heat treated. Accordingly, the composition of the natural soapstone plaques vary depending on the heat treatment conducted.

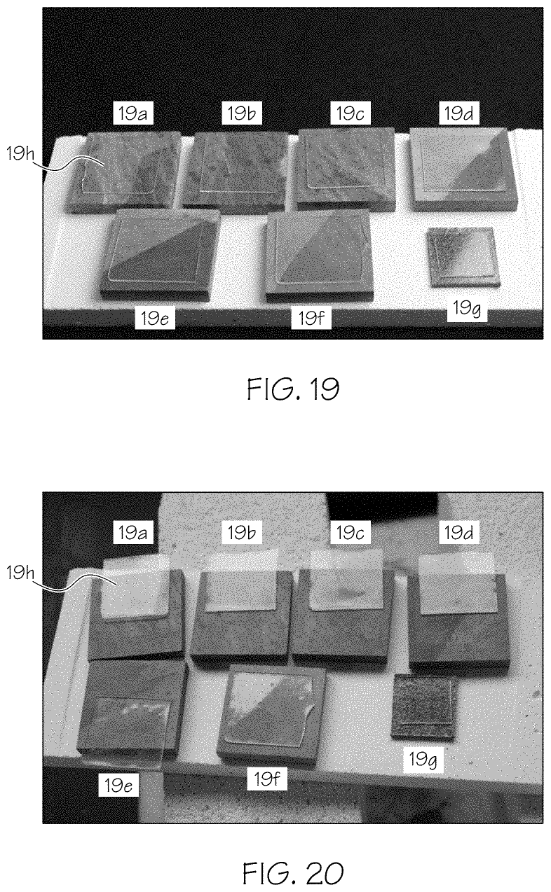

Referring now to FIG. 19, glass sheets were placed on soapstone plaques 19a-19f and mica plaque 19g and were heat treated at temperatures listed in Table 3 for a period of 24 hours.

TABLE 3

| Reference number | Type of plaque | Heat treatment temperature (° C.) |
|---|---|---|
| 19a | Soapstone | No treatment |
| 19b | Soapstone | 600 |
| 19c | Soapstone | 700 |
| 19d | Soapstone | 800 |
| 19e | Soapstone | 1000 |
| 19f | Soapstone | 1200 |
| 19g | Mica | 750 |

After heat treating and cooling the plaques 19a-19g to room temperature, the plaques 19a-19g with the glass sheets 19h thereon were subjected to an adhesion test as described hereinabove at an exposure temperature of 750° C. for 24 hours.

Referring now to FIG. 20, the soapstone plaques 19a-19e did not adhere to the glass sheets 19h. While not wishing to be bound by theory, it is believed that the soapstone plaques 19a-19e were unaffected by the thermal treatment because the soapstone plaques are primarily talc. Soapstone plaque 19f adhered to the glass sheet 19h until both the soapstone plaque 20f and the glass sheet 19h were fully cooled to room temperature. While not wishing to be bound by theory, it is believed that the 24 hour duration of the thermal treatment caused Van Der Waals bonding to occur between soapstone plaque 19f and glass sheet 19h. The mica plaque 19g fully fused to the glass sheet 19h. While not wishing to be bound by theory, mica fuses at 750° C. for 24 hours, but may not fuse to a glass sheet at less than or equal to 700° C. for 24 hours.

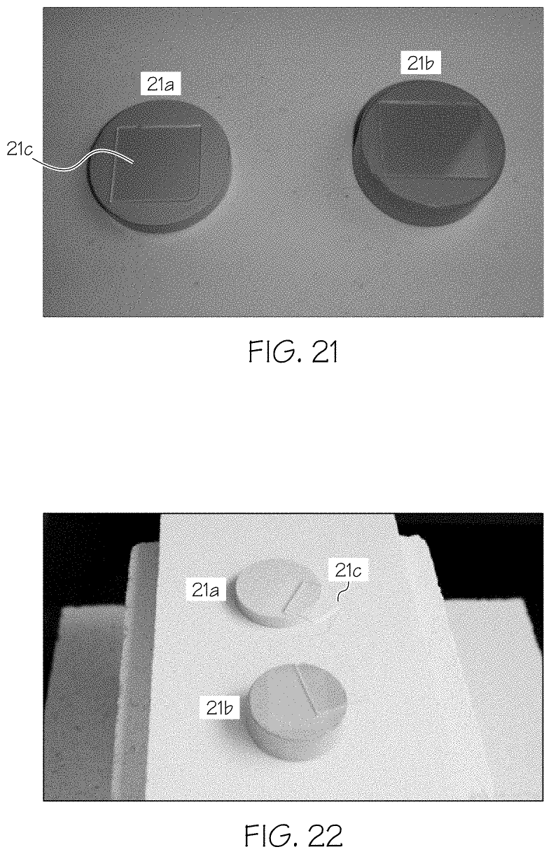

Referring now to FIG. 21, commercially available synthetic talc under the brand name ARTIC MIST from IMERYS and under the brand name FCOR from IMERYS were placed in a die and made into pellets 21a and 21b, respectively, by uniaxial pressing. The pellets were heat treated in an isothermal furnace at 900° C. for a period of 24 hours to sinter the material. After the pellets 21a and 21b cool to room temperature, glass sheets 21c were placed on the pellets 21a and 21b. The pellets 21a and 21b with the glass sheets 21c thereon were subjected to an adhesion test as described hereinabove.

Referring now to FIG. 22, the pellets 21a and 21b did not adhere to the glass sheets 21c. While not wishing to be bound by theory, it is believed the synthetic talc is functionally unaffected by the elevated temperatures of thermal tempering such that the glassware does not stick to the silicate material and may be easily removed after thermal tempering.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. An apparatus for holding glassware during processing, the apparatus comprising:
a plurality of ware keepers, each ware keeper configured to receive a piece of glassware during the processing, wherein:
each ware keeper comprises a glass contact surface comprising a silicate material having a Knoop hardness less than or equal to 400 HK₂₀₀ and a specific gravity greater than or equal to 1.5 and less than or equal to 6.

2. The apparatus of claim 1, wherein the silicate material comprises a phyllosilicate mineral.

3. The apparatus of claim 2, wherein the phyllosilicate mineral comprises talc, mica, or a combination thereof.

4. The apparatus of claim 1, wherein the silicate material comprises a tectosilicate mineral.

5. The apparatus of claim 4, wherein the tectosilicate mineral comprises quartz, feldspar, feldspathoid, or a combination thereof.

6. The apparatus of claim 5, wherein the feldspar comprises microcline, albite, sanidine, othroclase, labradorite, anorthite, or a combination thereof.

7. The apparatus of claim 5, wherein the feldspathoid comprises nepheline, leucite, or a combination thereof.

8. The apparatus of claim 1, wherein the silicate material has a specific gravity greater than or equal to 1.5 and less than or equal to 4.

9. The apparatus of claim 1, wherein the glass contact surface has a scratch parameter less than or equal to 75 μm with respect to the glassware contacting the glass contact surface as measured at an applied force less than or equal to 45 N.

10. The apparatus of claim 1, wherein the glass contact surface has a coefficient of friction less than or equal to 0.5 with respect to the glassware contacting the glass contact surface as measured at an applied force less than or equal to 45 N.

11. The apparatus of claim 1, wherein the silicate material does not adhere to the glassware contacting the glass contact surface at an exposure temperature less than or equal to 750° C. for 24 hours.

12. The apparatus of claim 1, wherein the processing is ion exchange.

13. The apparatus of claim 12, wherein the silicate material comprises feldspar.

14. The apparatus of claim 1, wherein the processing is annealing.

15. The apparatus of claim 14, wherein the silicate material comprise talc, mica, or a combination thereof.

16. The apparatus of claim 1, wherein the apparatus further comprises a base frame, wherein each ware keeper extends from the base frame and defines and circumscribes a glassware receiving volume in which the glassware is received and retained and the glass contact surface is positioned within the glassware receiving volume.

17. The apparatus of claim 16, wherein the plurality of ware keepers comprises a plurality of receiving slots, each receiving slot receiving at least a portion of the glassware, the plurality of receiving slots being arrayed in a linear array.

18. The apparatus of claim 1, wherein the apparatus further comprises a conveyor belt comprising a plurality of metal laths, wherein:
the plurality of ware keepers are positioned on the conveyor belt such that pairs of glass contact surfaces form glassware receiving slots on the conveyor belt; and
when the glassware is disposed on the conveyor belt within the glassware receiving slots, the glassware is exclusively contacted by the pairs of glass contact surfaces.

19. The apparatus of claim 18, wherein the glassware receiving slots are V-shaped.

20. The apparatus of claim 19, wherein the pairs of glass contact surfaces forming the glassware receiving slots are configured to contact at least one of a curved bottom edge and a neck of the glassware.
